(19) United States
(12) Patent Application Publication
(10) Pub. No.: US 2005/0218824 A1
(43) Pub. Date: Oct. 6, 2005

(54) Electronic ballast with regulating circuit and disturbance variable application

(75) Inventor: Olaf Busse, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/099,513

(22) Filed: Apr. 6, 2005

(30) Foreign Application Priority Data
Apr. 6, 2004 (DE) 102004016945.4

(51) Int. Cl. H05B 37/00

(52) U.S. Cl. 315/200 R

(57) ABSTRACT

The invention relates to an electronic ballast for lamps with a regulation of the lamp current I_{Li}. In this case, the intermediate circuit voltage U_{Zi} is taken into account by a disturbance variable application SG.

### FIELD OF THE INVENTION

The present invention relates to an electronic ballast for lamps, in particular but not exclusively low-pressure discharge lamps.

### BACKGROUND OF THE INVENTION

Such ballasts usually contain a rectifier that rectifies an AC supply voltage in order to generate an intermediate circuit voltage. This intermediate circuit voltage is usually present on an intermediate circuit capacitor for smoothing or storage. The intermediate circuit voltage supplies a converter, for example a half-bridge oscillator, which for its part generates the supply power for the lamp, a radiofrequency supply power in the case of a low-pressure discharge lamp, but also a DC voltage that alternates in polarity at a comparatively low frequency in the case of a high-pressure discharge lamp.

It is furthermore known to provide, in such ballasts, regulating circuits by means of which the lamp current or the lamp power is regulated to a constant value. It is thus possible to compensate for drift effects as a result of lamp aging, temperature changes and the like.

### SUMMARY OF THE INVENTION

The present invention is based on the technical problem of specifying an improved electronic ballast with a regulating circuit.

The invention relates to an electronic ballast for a lamp having a rectifier for generating a rectified intermediate circuit voltage, a converter for generating a supply power for the lamp, a control for the forced control of the converter and a regulating circuit for regulating the lamp current or the lamp power, which is designed to influence the control of the converter, characterized in that the ballast is designed to the effect that the control of the converter is also influenced by a disturbance variable application that takes account of fluctuations of the rectified intermediate circuit voltage.

The invention furthermore relates to a corresponding method.

The basic idea of the invention is as follows: in the course of rectifying the supply power, a residual modulation of the intermediate circuit voltage remains, in principle. This modulation influences the converter and thus the operation of the lamp. Although such a modulation can also be corrected in the case of a regulating circuit known per se, the inventor has ascertained that the intermediate circuit voltage modulation is comparatively fast in comparison with other disturbance variables such as lamp aging, temperature changes and the like and primarily in many cases is the only fast disturbance variable in this sense. Since the modulation behavior of the intermediate circuit voltage in the case of a known rectifier and a given intermediate circuit capacitor is relatively constant in the sense of predictable or calculable, the invention proposes taking account of the modulation of the intermediate circuit voltage as a disturbance variable in the context of a disturbance variable application outside the actual regulation feedback. This affords the advantage that the regulating circuit can be designed for significantly slower operation and the necessary measurements, for instance the lamp current measurement, can also be carried out correspondingly slowly. The feedback control loop thus becomes less demanding and the disturbance variable that is conventionally the cause of a relatively fast regulation is “excluded” and taken into account separately by means of the disturbance variable application. In this case, the disturbance variable application means “computationally” taking into account in the sense of—as a rule proportionally—taking into account the deviation of the disturbance variable from a nominal value in the case of the control of the converter.

A relatively slow I regulator may preferably be used, which is simple to realize and operates well in the case of slow regulations. It has the advantage, moreover, of not permitting a permanent regulating deviation.

Furthermore, it is preferred for the regulating circuit to be embodied digitally. A digital regulating circuit requires a limited technical outlay in any event when no stringent requirements are made of speed. Moreover, it is well suited to integration—which is preferred in the context of the invention—into a likewise digital control circuit, which is preferably realized by a microcontroller, that is to say a programmable IC. The regulating circuit can then therefore be realized essentially by software technology. In such cases in which, therefore, a digital circuit, in particular a microcontroller, is provided anyway for reasons independent of the regulation, the outlay required for the digital regulating circuit is significantly lower than that for a conventional analog regulating circuit. Here, too, the outlay can be significantly reduced in the case of minor speed requirements.

The ballast according to the invention preferably has a so-called power factor correction circuit, that is to say a circuit that provides for an as far as possible sinusoidal power consumption from the AC voltage mains. It is thus possible to avoid the pulsed current spikes that arise, in the event of simple charging of the intermediate circuit capacitor with a rectifier, when the mains voltage rises above the instantaneous intermediate circuit voltage. A preferred example of such a power factor correction circuit (also referred to as PFC circuit) are a so-called step-up converter (boost converter) and a so-called SEPIC converter, which are known per se.

The control of the power factor correction circuit requires a measurement of the intermediate circuit voltage anyway, so that the invention requires a particularly low additional outlay in such cases. In this case, the control of the power factor correction circuit is preferably likewise integrated in the digital control circuit.

### BRIEF DESCRIPTION OF THE DRAWINGS

The invention is explained in more detail below on the basis of a schematic exemplary embodiment, in which case the individual features may also be essential to the invention in other combinations. In particular it is expressly established once again that the invention has both a device character and a method character and the description above and also the description below implicitly relate to both aspects.

FIG. 1 shows a schematic block diagram of an analog regulating circuit in a conventional ballast.

FIG. 2 shows, in comparison with FIG. 1, a digital regulating circuit with disturbance variable application in a ballast according to the invention.

FIG. 3 shows a schematic block diagram of an electronic ballast according to the invention with a digital regulating circuit according to FIG. 2.

### DETAILED DESCRIPTION OF THE INVENTION

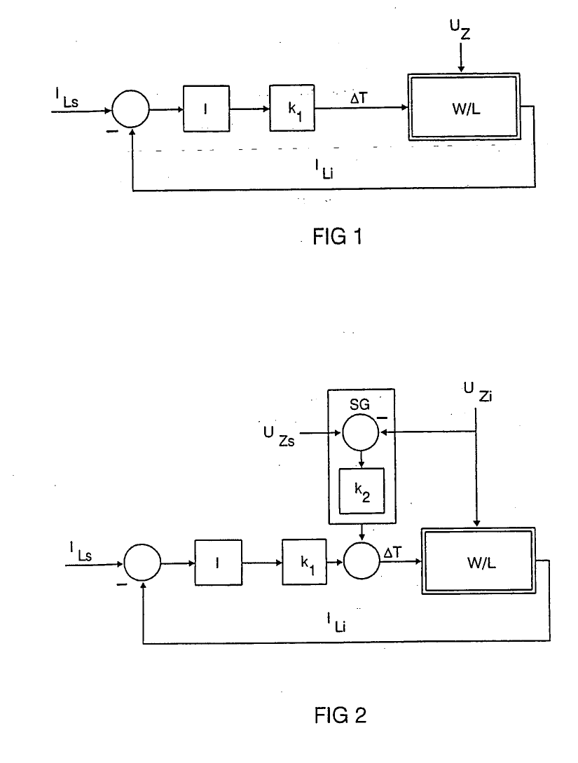

FIG. 1 shows a fast analog regulator for regulating the lamp current of a low-pressure discharge lamp according to the prior art. In FIG. 1, W/L designates a converter, here a half-bridge oscillator, with a connected low-pressure discharge lamp L. The signal line leading into the block W/L is designed by ΔT, which symbolizes that the switching times or the period duration of converter operation are set here. The signal line leading out of the block W/L is designated by I_{Li}, which symbolizes that the lamp current through the lamp L is measured here. It can be seen in the left-hand region of FIG. 1 that the measured “actual” lamp current I_{Li} is compared with a desired current value I_{Ls} by means of a comparator. The desired value deviation is fed to a fast analog integral regulating element designated by I. The output signal of the integral regulating element I is multiplied by a specific factor k₁ and, as already mentioned, used for setting the period duration T of converter operation. If the integral regulating element I outputs a zero signal, the period duration remains the same. Therefore, the signal line to the block W/L is designated by ΔT in the sense of a period duration change.

A further “signal” that passes into the block W/L in accordance with FIG. 1 is the intermediate circuit voltage U_{Z}. This symbolizes that converter operation and lamp operation, and also in particular the lamp current I_{Li} are dependent on the intermediate circuit voltage U_{Z} and, in particular, are subjected to the modulations thereof. The conventional control loop illustrated in FIG. 1 must therefore be fast enough to correct the intermediate circuit voltage modulation with a typical frequency of 100 Hz. In the case of high-quality electronic ballasts, the modulation of the lamp current or the lamp power must not exceed specific limits.

An alternative or else accompanying measure consists in choosing the intermediate circuit capacitor to be large enough in order to keep the intermediate circuit voltage modulation inherently small. However, a large intermediate circuit capacitor is associated with additional costs and, moreover, increases the switch-on current of the ballast.

FIG. 2 shows the invention in comparison with FIG. 1. In this case, the same reference symbols are used for corresponding parts. The following description concentrates on the differences.

Firstly, the intermediate circuit voltage is designated here by the symbol U_{Zi}. In contrast thereto, U_{Zs} designates an intermediate circuit voltage desired value. The intermediate circuit voltage actual value (measured value) U_{Zi} is compared with the intermediate circuit voltage desired value U_{Zs} by means of a comparator, multiplied by a constant k₂ and added to the output of the integral regulating element I multiplied by the constant k₁ as already described with reference to FIG. 1, in order to influence the period duration of converter operation in the manner already described. The constants k₁ and k₂ permit an adaptation of the behavior.

The unit—designated by the symbol SG—comprising the comparator for comparing the intermediate circuit voltage actual value U_{Zi} with the intermediate circuit voltage desired value U_{Zs} and the k₂ multiplication thus forms a disturbance variable application to the control loop which, for the rest, corresponds in principle to FIG. 1.

However, with the disturbance variable application SG, the intermediate circuit voltage modulation can be taken into account relatively rapidly in a sufficiently precise manner and primarily without a technical outlay. Therefore, in the case of the control loop according to FIG. 2, the lamp current I_{Li} does not have to be measured rapidly. Furthermore, the integral regulating element I can be slow. This is because the control loop now only has the task of correcting changes in converter and lamp operation that take place relatively slowly with respect to time.

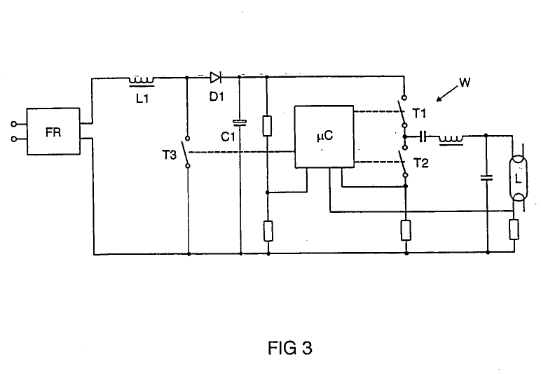

The arrangement described in FIG. 2 is part of a—for the rest—conventional electronic ballast for supplying a low-pressure discharge lamp L. FIG. 3 shows a block diagram in this respect. The intermediate circuit voltage U_{Zi} is generated by means of a conventional diode bridge rectifier with customary filter elements for preventing radiofrequency components from being fed back into the mains, designated by FR in FIG. 3. A power factor correction circuit is employed here, in this case a boost converter with the switching transistor T3, the inductance L1, the diode D1 and the storage capacitor C1 for the intermediate circuit voltage U_{Zi}. For the control of the switching transistor T3 of the boost converter, the intermediate circuit voltage U_{Zi} has to be measured anyway, which is illustrated in FIG. 3 by the tap at the voltage divider circuit (not specifically designated). In the case of this exemplary embodiment, this measurement is simultaneously used for the disturbance variable application illustrated in FIG. 2. Moreover, the disturbance variable application, the control loop, the control of the half-bridge oscillator W and the control of the boost converter are realized jointly by software technology in a digital microcontroller μC. The half-bridge oscillator W has the two switching transistors T1 and T2 from FIG. 3 and supplies the lamp circuit—which is connected up in a customary manner and not explained in any greater detail here—with the lamp L at the center tap between the switching transistors T1 and T2 with a supply voltage oscillating at high frequency. The microcontroller μC measures, in the manner indicated in FIG. 3, the current through the lamp L and the current through the lower switching transistor T2 in order to correspondingly drive the half-bridge oscillator W.

1. An electronic ballast for a lamp (L) having a rectifier for generating a rectified intermediate circuit voltage (U_{Z}),
a converter (W for generating a supply power for the lamp (L),
a control for the forced control of the converter (W) and a regulating circuit (I) for regulating the lamp current (I_{Li}) or the lamp power, which is designed to influence the control of the converter (W),
characterized in that the ballast is designed to the effect that the control of the converter (W) is also influenced by a disturbance variable application (SG) that takes account of fluctuations of the rectified intermediate circuit voltage (U_{Z}).

2. The ballast as claimed in claim 1, in which the regulating circuit is an I regulator (I).

3. The ballast as claimed in claim 1, in which the regulating circuit (I) operates digitally.

4. The ballast as claimed in claim 3, in which the regulating circuit (I) is integrated into a digital control circuit.

5. The ballast as claimed in claim 4, in which the digital control circuit is a microcontroller.

6. The ballast as claimed in claim 1 having a power factor correction circuit.

7. The ballast as claimed in claim 6, in which the control of the converter (W) is also designed for the control of the power factor correction circuit and the intermediate circuit voltage (U_{Z}) is measured uniformly for the control of the power factor correction circuit, on the one hand, and the disturbance variable application (SG) on the other hand.

8. A method for operating a lamp (L) with an electronic ballast as claimed in claim 1, in which
an AC supply voltage is rectified to form an intermediate circuit voltage (U_{Z}) by means of a rectifier,
a converter (W) is supplied with the intermediate circuit voltage (U_{Z}),
a supply power for the lamp (L) is generated by means of the converter (W),
the converter (W) is subjected to forced control by means of a control,
the lamp current (I_{Li}) or the lamp power is regulated by means of a regulating circuit and the control of the converter (W) is influenced in the process,
characterized in that the control of the converter (W) is also influenced by a disturbance variable application (SG) that takes account of fluctuations of the rectified intermediate circuit voltage (U_{Z}).

9. The ballast as claimed in claim 2, in which the regulating circuit (I) operates digitally
